(19) United States
(12) Patent Application Publication
(10) Pub. No.: US 2009/0006756 A1
(43) Pub. Date: Jan. 1, 2009

(54) CACHE MEMORY HAVING CONFIGURABLE ASSOCIATIVITY

(76) Inventor: Greggory D. Donley, San Jose, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/771,299

(22) Filed: Jun. 29, 2007

(51) Int. Cl. G06F 12/08

(52) U.S. Cl. 711/128; 711/E12.018

(57) ABSTRACT

A processor cache memory subsystem includes a cache memory having a configurable associativity. The cache memory may operate in a fully associative addressing mode and a direct addressing mode with reduced associativity. The cache memory includes a data storage array including a plurality of independently accessible sub-blocks for storing blocks of data. For example each of the sub-blocks implements an n-way set associative cache. The cache memory subsystem also includes a cache controller that may programmably select a number of ways of associativity of the cache memory. When programmed to operate in the fully associative addressing mode, the cache controller may disable independent access to each of the independently accessible sub-blocks and enable concurrent tag lookup of all independently accessible sub-blocks, and when programmed to operate in the direct addressing mode, the cache controller may enable independent access to one or more subsets of the independently accessible sub-blocks.

### BACKGROUND OF THE INVENTION

1. Field of the Invention

This invention relates to microprocessor caches and, more particularly, to cache accessibility and associativity.

2. Description of the Related Art

Since s computer system's main memory is typically designed for density rather than speed, microprocessor designers have added caches to their designs to reduce the microprocessor's need to directly access main memory. A cache is a small memory that is more quickly accessible than the main memory. Caches are typically constructed of fast memory cells such as static random access memories (SRAMs) which have faster access times and bandwidth than the memories used for the main system memory (typically dynamic random access memories (DRAMs) or synchronous dynamic random access memories (SDRAMs)).

Modern microprocessors typically include on-chip cache memory. In many cases, microprocessors include an on-chip hierarchical cache structure that may include a level one (L1), a level two (L2) and in some cases a level three (L3) cache memory. Typical cache hierarchies may employ a small fast L1, cache that may be used to store the most frequently used cache lines. The L2 may be a larger and possibly slower cache for storing cache lines that are accessed but don't fit in the L1. The L3 cache may be still larger than the L2 cache and may be used to store cache lines that are accessed but do not fit in the L2 cache. Having a cache hierarchy as described above may improve processor performance by reducing the latencies associated with memory access by the processor core.

Since L3 cache data arrays may be quite large in some systems, the L3 cache may be built with a high number of ways of associativity. This may minimize the chances that conflicting addresses or variable access patterns will evict an otherwise useful piece of data too soon. However, the increased associativity may result in increased power consumption due, for example, to the increased number of tag look ups that need to be performed for each access.

### SUMMARY

Various embodiments of a processor cache memory subsystem that includes a cache memory having a configurable associativity are disclosed. In one embodiment, the processor cache memory subsystem having a cache memory that includes a data storage array including a plurality of independently accessible sub-blocks for storing blocks of data. The cache memory further includes a tag storage array that store sets of address tags that correspond to the blocks of data stored within the plurality of independently accessible sub-blocks. The cache memory subsystem also includes a cache controller that may programmably select a number of ways of associativity of the cache memory. For example in one implementation each of the independently accessible sub-blocks implements an n-way set associative cache.

In one specific implementation, the cache memory may operate in a fully associative addressing mode and a direct addressing mode. When programmed to operate in the fully associative addressing mode, the cache controller may disable independent access to each of the independently accessible sub-blocks and enable concurrent tag lookup of all independently accessible sub-blocks. On the other hand, when programmed to operate in the direct addressing mode, the cache controller may enable independent access to one or more subsets of the independently accessible sub-blocks.

### BRIEF DESCRIPTION OF THE DRAWINGS

FIG. 1 is a block diagram of one embodiment of a computer system including a multi-core processing node.

FIG. 2 is a block diagram illustrating more detailed aspects of an embodiment of the L3 cache subsystem of FIG. 1.

FIG. 3 is a flow diagram describing the operation of one embodiment of the L3 cache subsystem.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

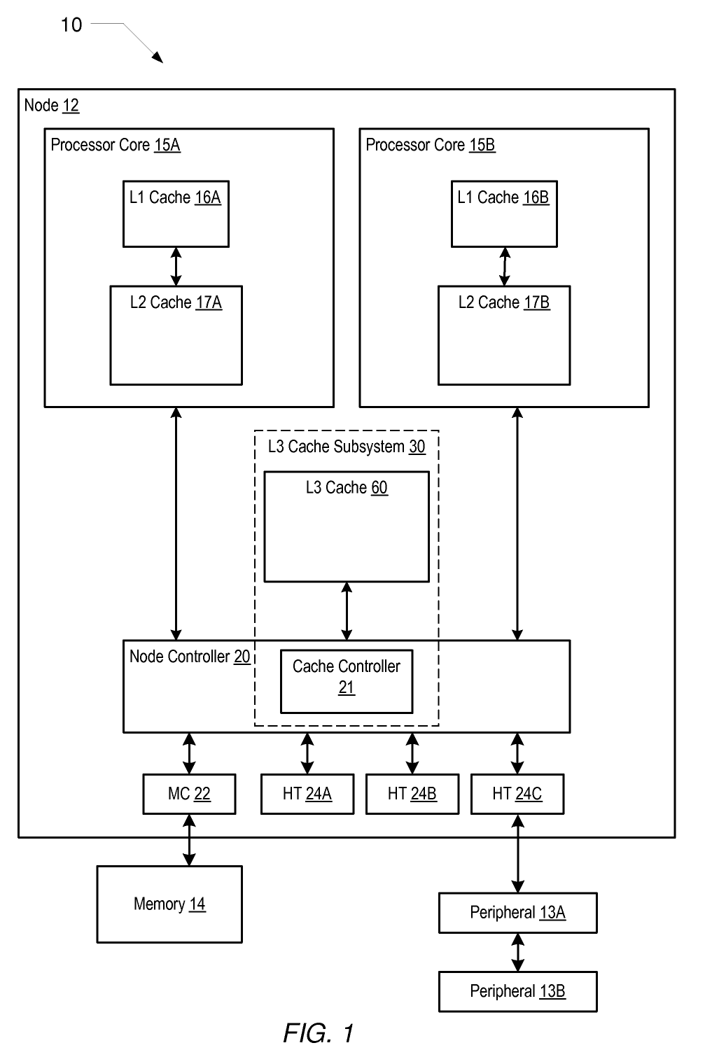

Turning now to FIG. 1, a block diagram of one embodiment of a computer system 10 is shown. In the illustrated embodiment, the computer system 10 includes a processing node 12 coupled to memory 14 and to peripheral devices 13A-13B. The node 12 includes processor cores 15A-15B coupled to a node controller 20 which is further coupled to a memory controller 22, a plurality of HyperTransport™ (HT) interface circuits 24A-24C, and a shared level three (L3) cache memory 60. The HT circuit 24C is coupled to the peripheral device 16A, which is coupled to the peripheral device 16B in a daisy-chain configuration (using HT interfaces, in this embodiment). The remaining HT circuits 24A-B may be connected to other similar processing nodes (not shown) via other HT interfaces (not shown). The memory controller 22 is coupled to the memory 14. In one embodiment, node 12 may be a single integrated circuit chip comprising the circuitry shown therein in FIG. 1. That is, node 12 may be a chip multiprocessor (CMP). Any level of integration or discrete components may be used. It is noted that processing node 12 may include various other circuits that have been omitted for simplicity.

In various embodiments, node controller 20 may also include a variety of interconnection circuits (not shown) for interconnecting processor cores 15A and 15B to each other, to other nodes, and to memory. Node controller 20 may also include functionality for selecting and controlling various node properties such as the maximum and minimum operating frequencies for the node, and the maximum and minimum power supply voltages for the node, for example. The node controller 20 may generally be configured to route communications between the processor cores 15A-15B, the memory controller 22, and the HT circuits 24A-24C dependent upon the communication type, the address in the communication, etc. In one embodiment, the node controller 20 may include a system request queue (SRQ) (not shown) into which received communications are written by the node controller 20. The node controller 20 may schedule communications from the SRQ for routing to the destination or destinations among the processor cores 15A-15B, the HT circuits 24A-24C, and the memory controller 22.

Generally, the processor cores 15A-15B may use the interface(s) to the node controller 20 to communicate with other components of the computer system 10 (e.g. peripheral devices 16A-16B, other processor cores (not shown), the memory controller 22, etc.). The interface may be designed in any desired fashion. Cache coherent communication may be defined for the interface, in some embodiments. In one embodiment, communication on the interfaces between the node controller 20 and the processor cores 15A-15B may be in the form of packets similar to those used on the HT interfaces. In other embodiments, any desired communication may be used (e.g. transactions on a bus interface, packets of a different form, etc.). In other embodiments, the processor cores 15A-15B may share an interface to the node controller 20 (e.g. a shared bus interface). Generally, the communications from the processor cores 15A-15B may include requests such as read operations (to read a memory location or a register external to the processor core) and write operations (to write a memory location or external register), responses to probes (for cache coherent embodiments), interrupt acknowledgements, and system management messages, etc.

As described above, the memory 14 may include any suitable memory devices. For example, a memory 14 may comprise one or more random access memories (RAM) in the dynamic RAM (DRAM) family such as RAMBUS DRAMs (RDRAMs), synchronous DRAMs (SDRAMs), double data rate (DDR) SDRAM. Alternatively, memory 14 may be implemented using static RAM, etc. The memory controller 22 may comprise control circuitry for interfacing to the memories 14. Additionally, the memory controller 22 may include request queues for queuing memory requests, etc.

The HT circuits 24A-24C may comprise a variety of buffers and control circuitry for receiving packets from an HT link and for transmitting packets upon an HT link. The HT interface comprises unidirectional links for transmitting packets. Each HT circuit 24A-24C may be coupled to two such links (one for transmitting and one for receiving). A given HT interface may be operated in a cache coherent fashion (e.g. between processing nodes) or in a non-coherent fashion (e.g. to/from peripheral devices 16A-16B). In the illustrated embodiment, the HT circuits 24A-24B are not in use, and the HT circuit 24C is coupled via non-coherent links to the peripheral devices 16A-16B.

The peripheral devices 16A-16B may be any type of peripheral devices. For example, the peripheral devices 16A-16B may include devices for communicating with another computer system to which the devices may be coupled (e.g. network interface cards, circuitry similar to a network interface card that is integrated onto a main circuit board of a computer system, or modems). Furthermore, the peripheral devices 16A-16B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. It is noted that the term “peripheral device” is intended to encompass input/output (I/O) devices.

Generally, a processor core 15A-15B may include circuitry that is designed to execute instructions defined in a given instruction set architecture. That is, the processor core circuitry may be configured to fetch, decode, execute, and store results of the instructions defined in the instruction set architecture. For example, in one embodiment, processor cores 15A-15B may implement the x86 architecture. The processor cores 15A-15B may comprise any desired configurations, including superpipelined, superscalar, or combinations thereof. Other configurations may include scalar, pipelined, non-pipelined, etc. Various embodiments may employ out of order speculative execution or in order execution. The processor cores may include microcoding for one or more instructions or other functions, in combination with any of the above constructions. Various embodiments may implement a variety of other design features such as caches, translation lookaside buffers (TLBs), etc. Accordingly, in the illustrated embodiment, in addition to the L3 cache 60 that is shared by both processor cores, processor core 15A includes an L1 cache 16A and an L2 cache 17A. Likewise, processor core 15B includes an L1 cache 16B and an L2 cache 17B. The respective L1 and L2 caches may be representative of any L1 and L2 cache found in a microprocessor.

It is noted that, while the present embodiment uses the HT interface for communication between nodes and between a node and peripheral devices, other embodiments may use any desired interface or interfaces for either communication. For example, other packet based interfaces may be used, bus interfaces may be used, various standard peripheral interfaces may be used (e.g., peripheral component interconnect (PCI), PCI express, etc.), etc.

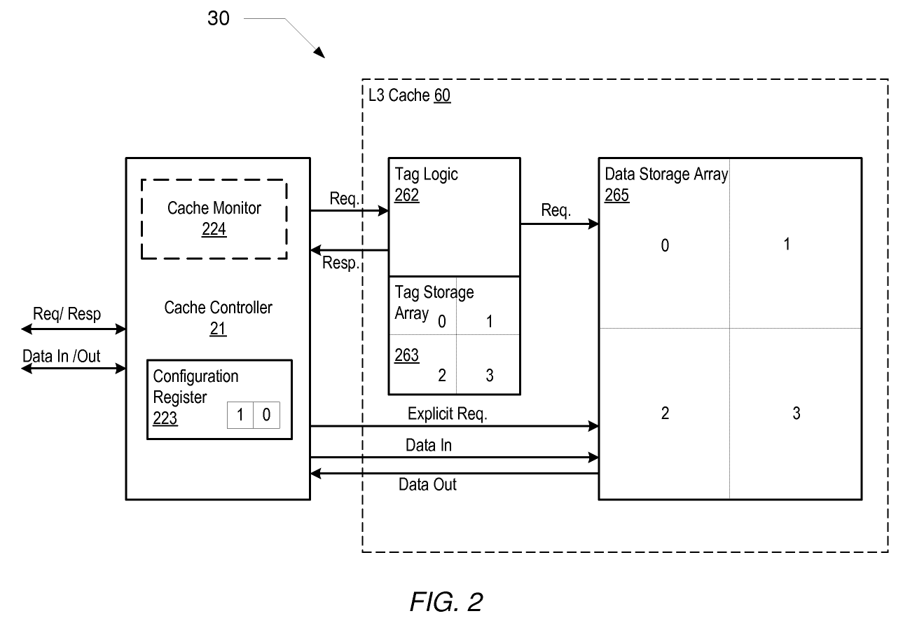

In the illustrated embodiment, the L3 cache subsystem 30 includes a cache controller unit 21 (which is shown as part of node controller 20) and the L3 cache 60. Cache controller 21 may be configured to control the operation of the L3 cache 60. For example, cache controller 21 may configure the L3 cache 60 accessibility by configuring the number of ways of associativity of the L3 cache 60. More particularly, as will be described in greater detail below, the L3 cache 60 may be divided into a number of separate independently accessible cache blocks or sub-caches (shown in FIG. 2). Each sub-cache may include a tag storage for a set of tags and associated data storage. In addition, each sub-cache may implement an n-way associative cache, where “n” may be any number. In various embodiments, the number of sub-caches, and therefore the number of ways of associativity of the L3 cache 60 is configurable.

It is noted that, while the computer system 10 illustrated in FIG. 1 includes one processing node 12, other embodiments may implement any number of processing nodes. Similarly, a processing node such as node 12 may include any number of processor cores, in various embodiments. Various embodiments of the computer system 10 may also include different numbers of HT interfaces per node 12, and differing numbers of peripheral devices 16 coupled to the node, etc.

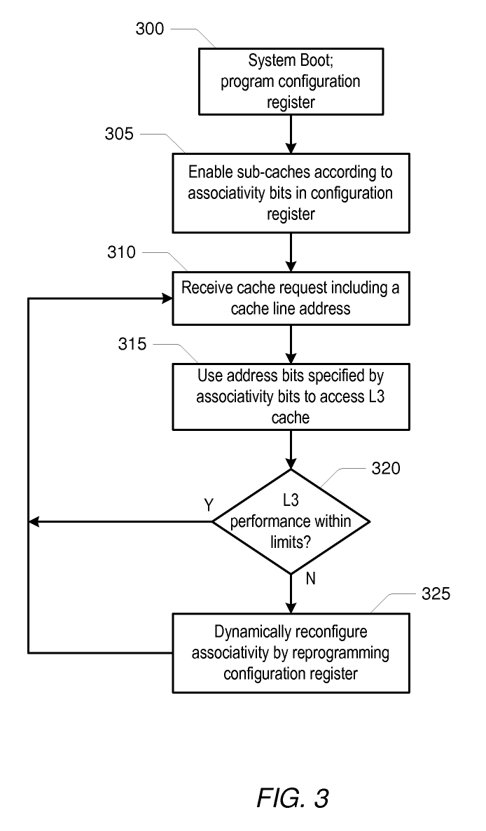

FIG. 2 is a block diagram illustrating more detailed aspects of an embodiment of the L3 cache subsystem of FIG. 1, while FIG. 3 is a flow diagram that describes the operation of one embodiment of the L3 cache subsystem 30 of FIG. 1 and FIG. 2. Components that correspond to those shown in FIG. 1 are numbered identically for clarity and simplicity. Referring collectively to FIG. 1 through FIG. 3, the L3 cache subsystem 30 includes a cache controller 21, which is coupled to L3 cache 60.

The L3 cache 60 includes a tag logic unit 262, a tag storage array 263, and a data storage array 265. As mentioned above, the L3 cache 60 may be implemented with a number of independently accessible sub-caches. In the illustrated embodiment, the dashed lines indicate the L3 cache 60 may be implemented with either two or four independently accessible segments or sub-caches. The data storage array 265 sub-caches are designated 0, 1, 2, and 3. Similarly the tag storage array 263 sub-caches are also designated 0, 1, 2, and 3.

For example, in an implementation with two sub-caches, the data storage array 265 may be divided such that the top (sub-caches 0 and 1 together) and bottom (sub-caches 2 and 3 together) might each represent a 16-way associative sub-cache. Alternatively, the left (sub-caches 0 and 2 together) and right (sub-caches 1 and 3 together) might each represent a 16-way associative sub-cache. In an implementation with four sub-caches, each of the sub-caches may represent a 16-way associative sub-cache. In this illustration, the L3 cache 60 may have 16, 32, or 64 ways of associativity.

Each portion of the tag storage array 263 may be configured to store within each of a plurality of locations a number of address bits (i.e., a tag) that corresponds to a cache line of data stored within an associated sub-cache of the data storage array 265. In one embodiment, depending on the configuration of the L3 cache 60, the tag logic 262 may search one or more sub-caches of the tag storage array 263 to determine whether a requested cache line is present in any of the sub-caches of the data storage array 265. If the tag logic 262 matches on a requested address, the tag logic 262 may return a hit indication to the cache controller 21, and a miss indication if there is no match found in the tag array 263.

In one specific implementation, each sub-cache may correspond to a set of tags and data implementing a 16-way associative cache. The sub-caches may be accessed in parallel such that a cache access request sent to the tag logic 262 may cause a tag lookup in each sub-cache of the tag array 263 at substantially the same time. As such, the associativity is additive. Thus, an L3 cache 60 configured to have two sub-caches would have up to 32-way associativity, and an L3 cache 60 configured to have four sub-caches would have up to 64-way associativity.

In the illustrated embodiment, cache controller 21 includes a configuration register 223 with two bits designated bit 0 and bit 1. The associativity bits may define the operation of L3 cache 60. More particularly, the associativity bits 0 and 1 within configuration register 223 may determine the number of address bits or hashed address bits used by the tag logic 262 to access the sub-caches, thus the cache controller 21 may configure the L3 cache 60 have any number of ways of associativity. Specifically, the associativity bits may enable and disable the sub-caches and thus whether the L3 cache 60 is accessed in a direct address mode (i.e., fully-associative mode off), or in a fully associative mode (See FIG. 3 block 305).

In embodiments with two sub-caches, which may be capable of 32-way associativity (e.g., top and bottom each capable of 16-way associativity), there may be only one active associativity bit. The associativity bit may enable either a “horizontal” or a “vertical” addressing mode. For example, if the associativity bit 0 is asserted, one address bit may select either the top or bottom pair, or the left or right pair. For example, in a two sub-cache implementation. If however, the associativity bit is deasserted, the tag logic 262 may access the sub-caches as a 32-way cache.

In embodiments with four sub-caches, which may be capable of up to 64-way associativity (e.g., each square capable of 16-way associativity), both associativity bits 0 and 1 may be used. The associativity bits may enable a “horizontal” and a “vertical” addressing mode in which both sub-caches in the top portion and bottom portion may be enabled as a pair, or both sub-caches in the left and right portions may be enabled as a pair. For example, if associativity bit 0 is asserted, tag logic 262 may use one address bit to select between the top or bottom pair, and if the associativity bit 1 is asserted, the tag logic 262 may use one address bit to select between the left or right pair. In either case, the L3 cache 60 may have a 32-way associativity. If both associativity bits 0 and 1 are asserted, the tag logic 262 may use two of the address bits to select a single sub-cache of the four, thus making the L3 cache 60 have a 16-way associativity. However, if both the associativity bits are deasserted, the L3 cache 60 is in a fully associative mode as all sub-caches are enabled, and tag logic 262 may access all sub-caches in parallel and the L3 cache 60 has 64-way associativity.

It is noted that in other embodiments, other numbers of associativity bits may be used. In addition, the functionality associated with the assertion and deassertion of the bits may be reversed. Further, it is contemplated that the functionality associated with each associativity bit may be different. For example, bit 0 may correspond to enabling left and right pairs, and bit 1 may correspond to enabling top and bottom pairs, and the like.

Thus, when a cache request is received, the cache controller 21 may forward the request including the cache line address to the tag logic 262. The tag logic 262 receives the request and may use the one or two of the address bits depending on which L3 cache 60 sub-caches are enabled as shown in blocks 310 and 315 of FIG. 3.

In many cases the type of application that is running on the computing platform or the type of computing platform may determine which level of associativity may have the best performance. For example, in some applications increased associativity may result in better performance. However, in some applications reduced associativity may not only provide better power consumption, but also improved performance since fewer resources may be consumed peer access allowing for greater throughput at lower latencies. Accordingly, in some embodiments, system vendors may provide the computing platform with a system basic input output system (BIOS) that programs the configuration register 223 with the appropriate default cache configuration as shown in block 300 of FIG. 3.

However, in other embodiments, the operating system may include a driver or a utility that may allow the default cache configuration to be modified. For example, in a laptop or other portable computing platform that may be sensitive to power consumption, reduced associativity may yield better power consumption, and so the BIOS may set the default cache configuration to be less associative. However, if a particular application may perform better with greater associativity, a user may access the utility and manually change the configuration register settings.

In another embodiment, as denoted by the dashed lines, cache controller 21 includes a cache monitor 224. During operation the cache monitor 224 may monitor cache performance using a variety of methods (See FIG. 3 block 320). Cache monitor 224 may be configured to automatically reconfigure the L3 cache 60 configuration based on its performance and/or a combination of performance and power consumption. For example, in one embodiment cache monitor 224 may directly manipulate the associativity bits if the cache performance is not within some predetermined limit. Alternatively, cache monitor 224 may notify the OS of a change in performance. In response to the notification, the OS may then execute the driver to program the associativity bits as desired (See FIG. 3 block 325).

In one embodiment, the cache controller 21 may be configured to reduce the latencies associated with accessing L3 cache 60 while preserving cache bandwidth by selectively requesting data from the L3 cache 60 using an implicit request, non-implicit request, or an explicit request dependent upon such factors as L3 resource availability, and L3 cache bandwidth utilization. For example, cache controller 21 may be configured to monitor and track outstanding L3 requests and available L3 resources such as the L3 data buses, and L3 storage array bank accesses.

In such an embodiment, data within each sub-cache may be accessed by two read buses supporting two concurrent data transfers. The cache controller 21 may be configured to keep track of which read buses and which data banks are busy or assumed to be busy due to any speculative reads. When a new read request s received, cache controller 21 may issue an implicit enabled request to the tag logic 262 in response to determining that the targeted bank is available and a data bus is available in all sub-caches. An implicit read request is a request issued by the cache controller 21 that results in the tag logic 262 initiating a data access to the data storage array 265 upon determining there is a tag hit, without intervention by the cache controller 21. Once the implicit request is issued, the cache controller 21 may internally mark those resources as busy for all sub-caches. After a fixed predetermined time period, cache controller 21 may mark those resources as ready since even if the resources were actually used (in the event of a hit), they would no longer be busy. However, if any of the required resources are busy, cache controller 21 may issue the request to tag logic 262 as a non-implicit request. When resources become available, cache controller 21 may issue directly to the data storage array 265 sub-cache known to contain the requested data, explicit requests that correspond to the non-implicit requests that returned a hit. A non-implicit request is a request that results in the tag logic 262 only returning the tag result to the cache controller 21. Accordingly, only a bank and a data bus in that sub-cache are made non-available (busy). Thus, more concurrent data transfers may be supported across all sub-caches when requests are predominantly issued as explicit requests. More information regarding embodiments that use implicit and explicit requests may be found in U.S. patent application Ser. No. 11/769,970, filed on Jun. 28, 2007, and entitled “APPARATUS FOR REDUCING CACHE LATENCY WHILE PRESERVING CACHE BANDWIDTH IN A CACHE SUBSYSTEM OF A PROCESSOR,” which is herein incorporated by reference in its entirety.

It is noted that although the embodiments described above include a node having multiple processor cores, it is contemplated that the functionality associated with L3 cache subsystem 30 may be used in any type of processor, including single core processors. In addition, the above functionality is not limited to L3 cache subsystems, but may be implemented in other cache levels and hierarchies as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor cache memory subsystem comprising:
a cache memory having a configurable associativity, wherein the cache memory includes:
a data storage array including a plurality of independently accessible sub-blocks for storing blocks of data; and
a tag storage array for storing sets of address tags that correspond to the blocks of data stored within the plurality of independently accessible sub-blocks;
a cache controller configured to programmably select a number of ways of associativity of the cache memory.

2. The cache memory subsystem as recited in claim 1, wherein each of the independently accessible sub-blocks implements an n-way set associative cache.

3. The cache memory subsystem as recited in claim 1, wherein the cache memory is configured to operate in a fully associative addressing mode and a direct addressing mode.

4. The cache memory subsystem as recited in claim 3, wherein, when programmed to operate in the fully associative addressing mode, the cache controller is configured to disable independent access to each of the independently accessible sub-blocks and to enable concurrent tag lookup of all independently accessible sub-blocks.

5. The cache memory subsystem as recited in claim 3, wherein, when programmed to operate in the direct addressing mode, the cache controller is configured to enable independent access to one or more subsets of the independently accessible sub-blocks.

6. The cache memory subsystem as recited in claim 5, wherein the cache controller includes a configuration register comprising one or more associativity bits, wherein each associativity bit is associated with a subset of the independently accessible sub-blocks.

7. The cache memory subsystem as recited in claim 6, wherein the cache memory further includes a tag logic unit coupled to the tag storage array and configured to use one or more address bits included in a cache request to direct a cache access to a given subset of the independently accessible sub-blocks dependent upon which of the associativity bits are asserted.

8. The cache memory subsystem as recited in claim 6, wherein each associativity bit is associated with two pairs of the independently accessible sub-blocks.

9. The cache memory subsystem as recited in claim 8, wherein the cache memory further includes a tag logic unit coupled to the tag storage array and configured to use one address bit included in a cache request to direct a cache access to a given pair of the independently accessible sub-blocks dependent upon which one of the associativity bits are asserted.

10. The cache memory subsystem as recited in claim 8, wherein the cache memory further includes a tag logic unit coupled to the tag storage array and configured to use two address bits included in a cache request to direct a cache access to a respective one of the independently accessible sub-blocks in response to two of the associativity bits being asserted.

11. The cache memory subsystem as recited in claim 6, wherein the configuration register is programmed by a basic input/output (BIOS) routine during boot-up of a processor that includes the cache subsystem.

12. The cache memory subsystem as recited in claim 8, wherein the cache controller further comprises a cache monitor configured to monitor cache subsystem performance and cause the configuration register to be automatically reprogrammed based upon the cache subsystem performance.

13. A method of configuring a processor cache memory subsystem, the method comprising:
storing blocks of data within a data storage array of a cache memory having a plurality of independently accessible sub-blocks;
storing within a tag storage array, sets of address tags that correspond to the blocks of data stored within the plurality of independently accessible sub-blocks;
programmably selecting a number of ways of associativity of the cache memory.

14. The method as recited in claim 13, wherein each of the independently accessible sub-blocks implements an n-way set associative cache.

15. The method as recited in claim 13, further comprising operating the cache memory in a fully associative addressing mode and a direct addressing mode.

16. The method as recited in claim 15, further comprising disabling independent access to each of the independently accessible sub-blocks and enabling concurrent tag lookup of all independently accessible sub-blocks to operate the cache memory in the fully associative addressing mode.

17. The method as recited in claim 15, further comprising enabling independent access to one or more subsets of the independently accessible sub-blocks to operate in the direct addressing mode.

18. The method as recited in claim 17, further comprising providing a configuration register including one or more associativity bits, wherein each associativity bit is associated with a subset of the independently accessible sub-blocks.

19. The method as recited in claim 18, further comprising using one or more address bits included in a cache request to direct a cache access to a given subset of the independently accessible sub-blocks dependent upon which of the associativity bits are asserted.

20. The method as recited in claim 18, wherein each associativity bit is associated with two pairs of the independently accessible sub-blocks.

21. The method as recited in claim 18, further comprising using one address bit included in a cache request to direct a cache access to a given pair of the independently accessible sub-blocks dependent upon which one of the associativity bits are asserted.

22. The method as recited in claim 18, further comprising using two address bits included in a cache request to direct a cache access to a respective one of the independently accessible sub-blocks in response to two of the associativity bits being asserted.
